(19) United States
(12) Patent Application Publication
(10) Pub. No.: US 2007/0300208 A1
(43) Pub. Date: Dec. 27, 2007

(54) Development support system and development support method

(75) Inventors: Itaru Furukawa, Kyoto (JP); Hiroshi Yamamoto, Kyoto (JP); Kiyotaka Kasubuchi, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/806,307

(22) Filed: May 31, 2007

(30) Foreign Application Priority Data
Jun. 26, 2006 (JP) JP2006-174918

(51) Int. Cl. G06F 9/44

(52) U.S. Cl. 717/127

(57) ABSTRACT

In a development support system, an influence extent management database is previously created and stored. The extent of influence of correction, if any, of each “request” (or “program”) is stored in the influence extent management database. Thus, associations are established between a “request,” a program required to be corrected when the request is corrected, and a test case required to be executed after the correction. Associations are also established between a “program” and a test case required to be executed when the program is corrected. When an instruction to correct a program is provided, for example, because of the occurrence of a failure, the development support system specifies the “program” to be corrected to acquire the extent of influence of the “program” from the influence extent management database, thereby executing only a test case included in the acquired influence extent as an operation retest. This achieves the extraction of test cases to be executed after the correction within minimum required limits.

### BACKGROUND OF THE INVENTION

1. Field of the Invention

The present invention relates to a technique for development of programs.

2. Description of the Background Art

In the step of developing a program, a variety of operation tests are conducted to check whether or not the created program operates properly. Specifically, the operation of correcting a bug in a program each time the bug is detected is repeatedly performed by conducting the variety of operation tests during the development of the program.

Test details (for example, conditions provided to a program) on operation tests are determined by generating a “test case” corresponding to each of the operation tests. In other words, operation tests are conducted on a program in accordance with a plurality of test cases, respectively, and the program is regarded as being acceptable if the operation tests in accordance with all of the test cases show successful results.

On the other hand, a normal program (or a main program) is developed as a collection of programs (or functional programs). If a bug is detected in the main program in accordance with a test case, one or more functional programs are corrected in accordance with the detected bug. Thereafter, an operation test (an operation retest) is conducted again on the main program in accordance with the test case to check whether or not the detected bug is eliminated.

Typically, a plurality of test cases are determined for one program. For this reason, even when a bug is eliminated in a test case in which the bug is detected, a new bug sometimes arises in another test case (for example, a test case which has already shown a successful result). That is, the correction of the program sometimes exerts an influence upon a plurality of test cases. This presents a problem such that the conduct of the operation retest in accordance with only the test case in which the bug is detected is insufficient in some cases.

If a failure occurs, there are, however, various combinations of functional programs to be corrected in accordance with the failure. It is hence difficult to extract only a test case subject to the influence from among a plurality of test cases. On the other hand, there are a vast number of test cases to be determined for one main program, and it is inefficient to retry all of the test cases each time a failure occurs.

### SUMMARY OF THE INVENTION

The present invention is intended for a technique for supporting development of a program.

According to one aspect of the present invention, a development support system for supporting development of a program comprises: an input part for accepting an instruction input from an operator; an influence extent management part for previously holding the extent of influence of each program, based on the instruction input accepted by the input part; an acquisition part, based on an instruction input accepted by the input part and indicating program correction, for specifying a to-be-corrected program from the instruction input indicating the program correction to acquire the extent of influence of the to-be-corrected program from the extent of influence of each program held in the influence extent management part; and a specification part for specifying an influenceable test case, based on the extent of influence of the to-be-corrected program acquired by the acquisition part, the influenceable test case being a test case to be executed after correction of the to-be-corrected program based on the instruction input indicating the program correction is completed.

Thus, the extent of influence of each program is previously held. The development support system specifies the influenceable test case which is the test case to be executed after the correction of the to-be-corrected program based on the instruction input indicating the program correction is completed, based on the extent of influence of the to-be-corrected program, to thereby facilitate the recognition of a test case required to be corrected because of the correction, if any, of a program. This allows the conduct of tests without omission on the program to achieve high-quality program development.

Preferably, the influence extent management part previously holds the extent of influence of each request corresponding to a program, based on the instruction input accepted by the input part; based on an instruction input accepted by the input part and indicating request correction, the acquisition part specifies a to-be-corrected request from the instruction input indicating the request correction to acquire the extent of influence of the to-be-corrected request from the extent of influence of each request held in the influence extent management part; and the specification part specifies the influenceable test case, based on the extent of influence of the to-be-corrected request acquired by the acquisition part, the influenceable test case being a test case to be executed after correction of the to-be-corrected request based on the instruction input indicating the request correction is completed.

The present invention is also intended for a method of supporting development of a program, and for a recording medium with a development support program recorded thereon.

It is therefore an object of the present invention to extract test cases to be executed after correction of a program and the like within minimum required limits.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a development support system according to the present invention;

FIG. 2 shows the construction of a management device;

FIG. 3 is a functional block diagram of the management device;

FIG. 4 shows the construction of a programming device;

FIG. 5 shows the construction of an evaluation device;

FIG. 6 is a simplified flow diagram showing the operation of registering information into databases of the management device;

FIG. 7 illustrates a new record registered in a request management database;

FIG. 8 illustrates a new record registered in a program management database;

FIG. 9 illustrates a new record registered in a test case management database;

FIG. 10 shows an example of a list of “requests” and “programs” with unregistered influence extents by means of IDs;

FIG. 11 illustrates an influence extent management database with a new record registered therein;

FIG. 12 is a flow diagram showing an operation check process for a product program (or functional program);

FIG. 13 shows an example of pieces of information stored in a test case;

FIG. 14 is a flow diagram showing a result input process;

FIG. 15 is a flow diagram showing a result registration process;

FIG. 16 illustrates the test case management database about a test case in accordance with which a failure occurs in an operation test;

FIG. 17 illustrates a new record added to a failure management database;

FIGS. 18 and 19 are flow diagrams showing a correction input process;

FIG. 20 illustrates the program management database as updated;

FIG. 21 illustrates the failure management database as updated;

FIG. 22 illustrates records in the test case management database as updated;

FIG. 23 illustrates the request management database as updated;

FIG. 24 illustrates records in the test case management database as updated; and

FIG. 25 is a flow diagram showing the operation in a correction job process.

### DESCRIPTION OF THE PREFERRED EMBODIMENTS

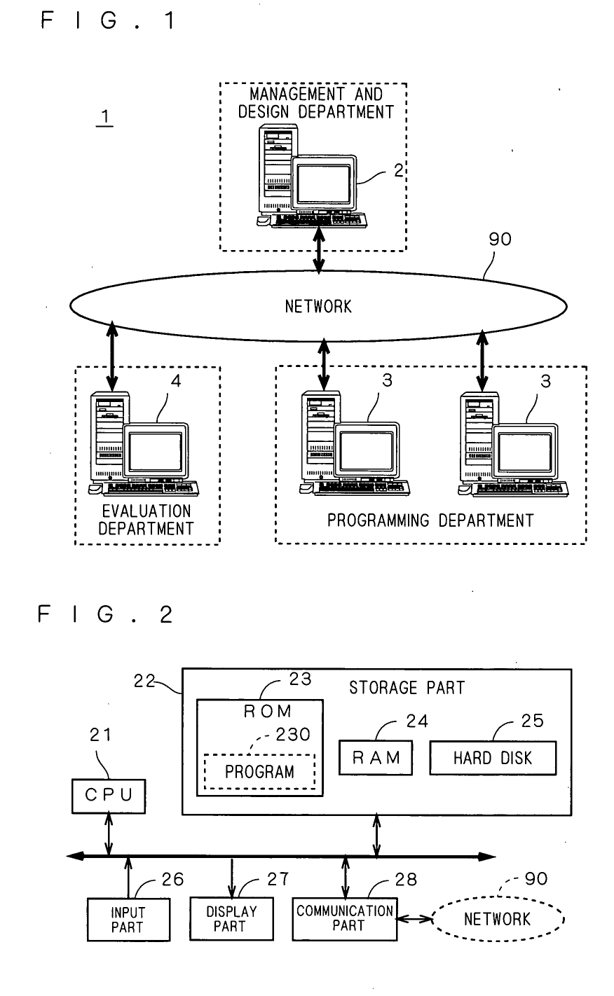

FIG. 1 shows a development support system 1 according to the present invention. A management and design department shown in FIG. 1 is a department for designing a program (referred to hereinafter as a “product program”) to be developed (or produced) in the development support system 1 and for managing various pieces of information about the product program. A management device 2 is placed in the management and design department. A programming department is a department for actually creating the product program. Programming devices 3 are placed in the programming department. An evaluation department is a department for conducting an operation test (and an operation retest) on the product program created in the programming department to thereby evaluate the product program. An evaluation device 4 is placed in the evaluation department.

The development support system 1 principally includes the management device 2, the programming devices 3 and the evaluation device 4, and is constructed in such a manner that the management device 2, the programming devices 3 and the evaluation device 4 are connected to each other through a network 90 for data communication with each other. Each of the management device 2 and the evaluation device 4 may be implemented by a plurality of devices. The number of programming devices 3 is not limited to two, but a single programming device 3 or more than two programming devices 3 may be placed in the programming department.

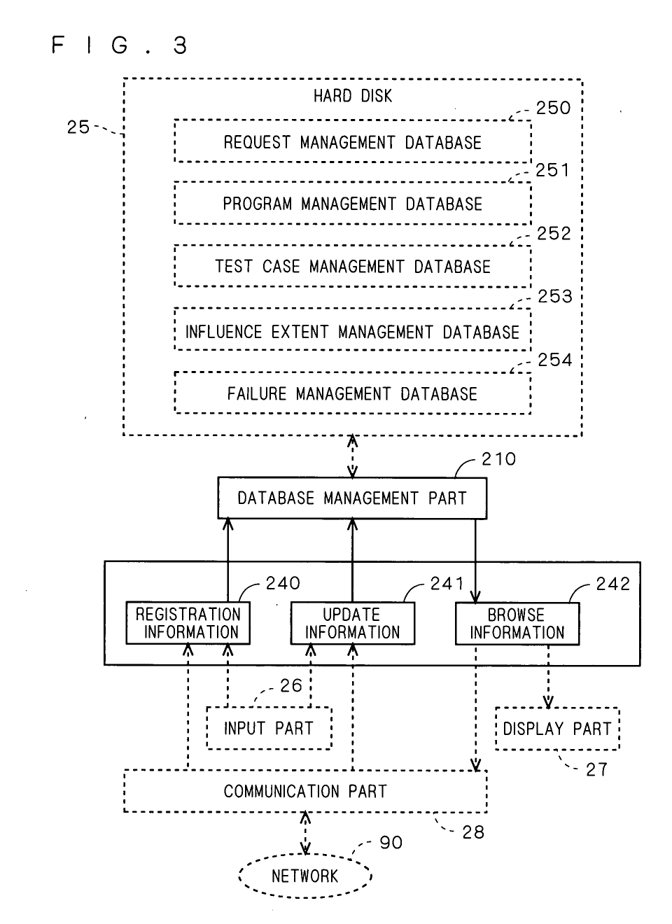

FIG. 2 shows the construction of the management device 2.

The management device 2 includes a CPU 21, a storage part 22, an input part 26, a display part 27 and a communication part 28, and has capabilities of a typical personal computer. A manager and a designer principally manipulate and use the management device 2 the details of which will be described later to manage pieces of information about the product program in an integrated fashion.

The CPU 21 performs computations on various data to control the constituents of the management device 2. The storage part 22 principally includes a ROM 23 for storing a program 230 therein, a RAM 24 serving as a temporary work area for the CPU 21, and a hard disk 25 for storing relatively large-volume data over a prolonged period.

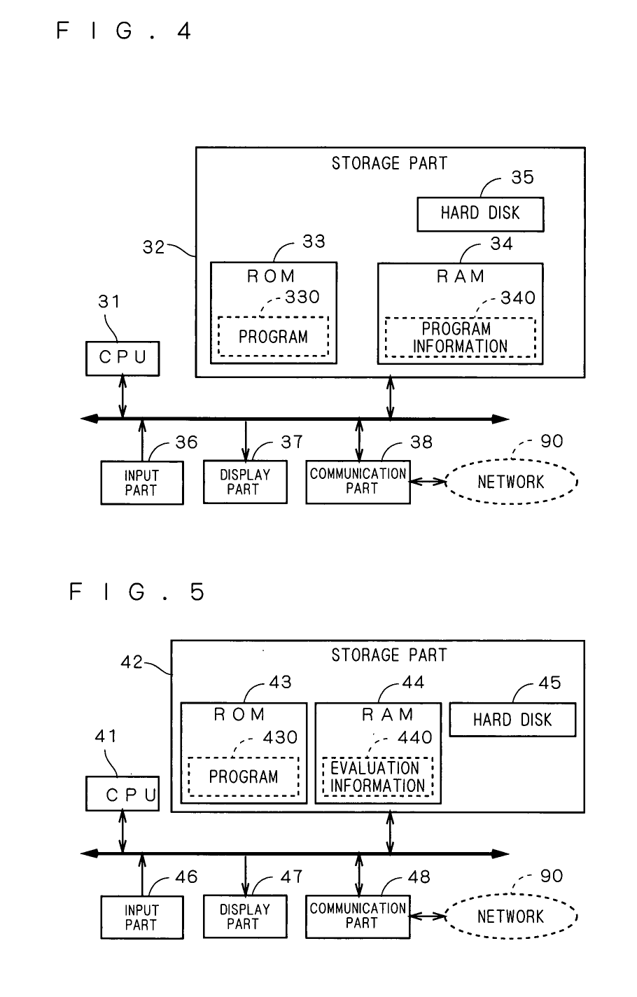

FIG. 3 is a functional block diagram of the management device 2. The functional blocks shown in FIG. 3 are implemented principally by the CPU 21 operating in accordance with the program 230 so that a database management part 210 shown in FIG. 3 manages various databases stored in the hard disk 25.

Prior to the description about the database management part 210, the various databases stored in the hard disk 25 of the management device 2 will be described.

A request management database 250, a program management database 251, a test case management database 252, an influence extent management database 253 and a failure management database 254 are stored in the hard disk 25, as illustrated in FIG. 3.

The request management database 250 is a database for storing an identifier (referred to hereinafter as a “request ID”) for identification of each individual “request” and information about the request identified by the corresponding request ID in association with each other. That is, the request management database 250 includes records provided for individual requests, respectively, and the pieces of information stored in the records are retrievable by using the request IDs. All of the requests made for the product program are registered in the request management database 250.

The requests termed herein refer to requests (specifications and the like) for the product program, and the concept thereof is dominant over program management. Specifically, the requests include a title, a brief description, a detailed description, a development status, progress, and the like, which will be described in detail later.

The program management database 251 is a database for storing an identifier (referred to hereinafter as a “program ID”) for identification of each individual “functional program” and information about the functional program identified by the corresponding program ID in association with each other. That is, the program management database 251 includes records provided for individual functional programs, respectively, and the pieces of information stored in the records are retrievable by using the program IDs. All of the functional programs made for the product program are registered in the program management database 251.

The functional programs termed herein refer to programs corresponding to a plurality of functions constituting the product program. In the following description, the functional programs are sometimes referred to simply as programs. The information about the functional programs specifically includes a program category, a program item name, a program detail, and the like, which will be described in detail later.

The test case management database 252 is a database for storing an identifier (referred to hereinafter as a “test case ID”) for identification of each individual “test case” and information about the test case identified by the corresponding test case ID in association with each other. That is, the test case management database 252 includes records provided for individual test cases, respectively, and the pieces of information stored in the records are retrievable by using the test case IDs. All of the test cases made for the product program are registered in the test case management database 252.

The test cases termed herein define operation tests for the inspection of the product program (or functional program). The information about the test cases specifically includes a test category, a test item name, a test detail, a test creator, and the like, which will be described in detail later.

The influence extent management database 253 is a database for storing a “program ID” and the extent of influence of the functional program identified by the program ID in association with each other. Also, the influence extent management database 253 stores a “request ID” and the extent of influence of the request identified by the request ID in association with each other.

That is, the influence extent management database 253 includes records provided for individual functional programs or for individual requests, respectively, and the pieces of information stored in the records are retrievable by using the program IDs or the request IDs.

The extent of influence of a functional program is the extent to which a correction to the functional program exerts influence, and specifically represents a test case (referred to hereinafter as an “influenceable test case”) which is required to be executed when the functional program is corrected. The extent of influence of a request is the extent to which a correction to the request exerts influence, and specifically represents a functional program which is required to be corrected and a test case which is required to be executed when the request is corrected.

The failure management database 254 is a database for storing an identifier (referred to hereinafter as a “failure ID”) for identification of each individual “failure” and information about the failure identified by the corresponding failure ID in association with each other. That is, the failure management database 254 includes records provided for individual failures, respectively, and the pieces of information stored in the records are retrievable by using the failure IDs.

The failures termed herein refer to those caused when an operation test is conducted on the product program (or functional program) in accordance with a test case. The information about the failures specifically includes a failure item name, a failure detail, a detected test case ID (the test case ID corresponding to a test case in which the failure is detected), a detector, a significance, and the like, which will be described in detail later.

Based on a database ID indicated in registration information 240, the database management part 210 creates a new record in the database identified by the database ID. Also, the database management part 210 stores various pieces of information included in the registration information 240 in the created new record, to thereby register the registration information 240 in the database.

The database ID refers to an identifier for identification of each individual database (the request management database 250, the program management database 251, the test case management database 252, the influence extent management database 253 and the failure management database 254) stored in the hard disk 25.

Based on a database ID indicated in update information 241, the database management part 210 updates the database identified by the database ID. More specifically, the database management part 210 rewrites the information stored in a record already registered in the database by using the information included in the update information 241.

Based on a browse request (not shown), the database management part 210 generates browse information 242. The browse request includes an identifier (referred to hereinafter as a “requester ID”) indicating a requester that requests a browse, a database ID indicating the database requested to be browsed, and an identifier (referred to hereinafter as a “browse record ID”) indicating a record of the database identified by the database ID.

Based on the database ID and the browse record ID included in the browse request, the database management part 210 searches the database identified by the database ID. Then, the database management part 210 extracts information stored in the record of the database identified by the browse record ID to generate the browse information 242.

Of the pieces of information stored in the database, the information requested to be browsed by the browse request and the requester ID that requested the browse (which serves as information indicating a destination to which the browse information 242 is to be transmitted) are included in the browse information 242 generated in a manner described above. In other words, the database management part 210 has a capability as a search engine for the databases stored in the hard disk 25.

In the development support system 1 according to the preferred embodiment, the requester ID serves as the information for identification of the management device 2, the programming devices 3 or the evaluation device 4. The browse record ID is information differing depending on the databases in which the information requested to be browsed is stored. Examples of the browse record ID are the request ID, the program ID, the test case ID, the failure ID and the like.

The registration information 240, the update information 241 and the browse request are not only acquired from the input part 26 but also acquired in some cases through the communication part 28 from the programming devices 3 and the evaluation device 4. Similarly, the browse information 242 is not only displayed on the display part 27 but also transmitted in some cases through the communication part 28 to the programming devices 3 and the evaluation device 4.

Referring again to FIG. 2, the input part 26 includes a keyboard, a mouse, and the like. The input part 26 is manipulated by an operator to thereby accept various instructions and various pieces of information from the operator.

The display part 27 is a typical display device which displays various data on a screen thereof. In particular, the display part 27 displays the browse information 242.

The communication part 28 has the capability of connecting the management device 2 to the network 90. This enables the management device 2 to perform data communication with the programming devices 3 and the evaluation device 4.

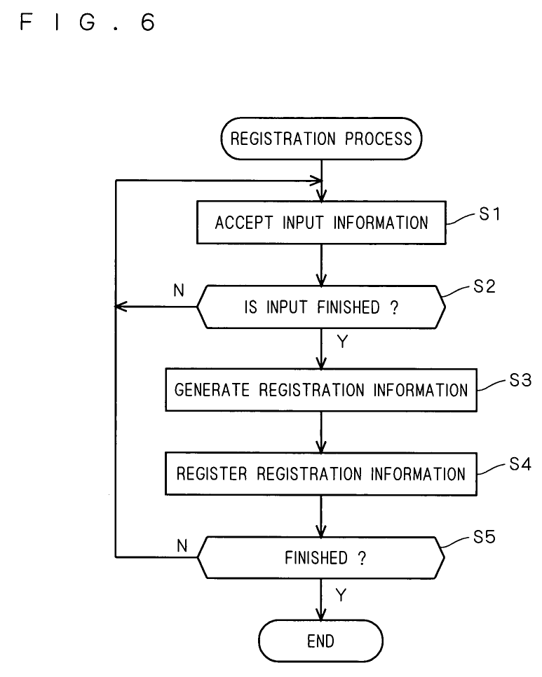

FIG. 4 shows the construction of each of the programming devices 3. A programmer principally manipulates the programming device 3. The programming device 3 is used for production of the product program (or functional program), and is also used for the input of program information 340. The program information 340 includes a program ID and information about the functional program identified by the program ID.

The programming device 3 includes a CPU 31, a storage part 32, an input part 36, a display part 37 and a communication part 38, and has capabilities of a typical personal computer. Although the details are not shown, the programming device 3 includes tools (an editor, a compiler, a linker, a debugger and the like) for creation of the product program (or functional program).

The CPU 31 performs computations on various data to control the constituents of the programming device 3. The storage part 32 principally includes a ROM 33 for storing a program 330 therein, a RAM 34 serving as a temporary work area for the CPU 31, and a hard disk 35 for storing relatively large-volume data over a prolonged period. For example, a functional program created by the programmer is stored in the hard disk 35.

The input part 36 includes a keyboard, a mouse, and the like. The input part 36 is manipulated by an operator (or programmer) to thereby accept various instructions and various pieces of information from the operator. In particular, the operator manipulates the input part 36 to thereby input the program information 340.

The display part 37 is a typical display device which displays various data on a screen thereof. In particular, the display part 37 displays the browse information 242. A conceivable example of the browse information 242 displayed on the display part 37 includes information for indicating a correction to the functional program, and the like.

The communication part 38 has the capability of connecting the programming device 3 to the network 90. This enables the programming device 3 to perform data communication with the management device 2 and the evaluation device 4.

FIG. 5 shows the construction of the evaluation device 4. A tester principally manipulates the evaluation device 4. The evaluation device 4 is used for execution of a test case on the product program (or functional program), and is also used for the input of evaluation information 440. The evaluation information 440 includes a test case ID and information about the result of the execution of the test case identified by the test case ID.

The evaluation device 4 includes a CPU 41, a storage part 42, an input part 46, a display part 47 and a communication part 48, and has capabilities of a typical personal computer. Although the details are not shown, the evaluation device 4 includes a constituent (for example, a device in which the product program operates) required for the operation test of the product program (or functional program).

The CPU 41 performs computations on various data to control the constituents of the evaluation device 4. The storage part 42 principally includes a ROM 43 for storing a program 430 therein, a RAM 44 serving as a temporary work area for the CPU 41, and a hard disk 45 for storing relatively large-volume data over a prolonged period.

The input part 46 includes a keyboard, a mouse, and the like. The input part 46 is manipulated by an operator (or tester) to thereby accept various instructions and various pieces of information from the operator. In particular, the operator manipulates the input part 46 to thereby input the evaluation information 440.

The display part 47 is a typical display device which displays various data on a screen thereof. In particular, the display part 47 displays the browse information 242. A conceivable example of the browse information 242 displayed on the display part 47 includes a list of test cases, and the like.

The communication part 48 has the capability of connecting the evaluation device 4 to the network 90. This enables the evaluation device 4 to perform data communication with the management device 2 and the programming devices 3.

The construction and capabilities of the development support system 1 according to the preferred embodiment have been described above.

Next, the operation of the development support system 1 will be described.

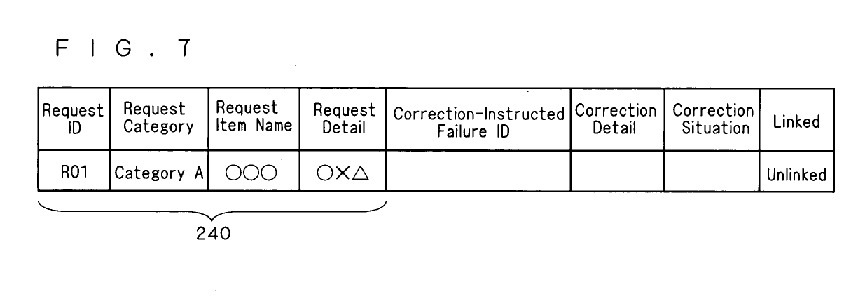

FIG. 6 is a simplified flow diagram showing the operation of registering information into the databases of the management device 2.

When the registration process starts, information (input information) inputted by an operator is accepted (in Step S1). Step S1 is repeated until the input is finished (in Step S2). The input information is accepted by any of the input parts 26, 36 and 46.

After the input is finished, the registration information 240 is generated, based on the input information (in Step S3). When the registration information 240 is generated in a device (the programming devices 3 or the evaluation device 4) other than the management device 2, the generated registration information 240 is transmitted to the management device 2. Specifically, the registration information 240 generated in the development support system 1 is transmitted to the RAM 24 of the management device 2.

Next, the database management part 210 of the management device 2 registers the registration information 240 transmitted to the RAM 24 into a corresponding one of the databases (in Step S4).

Also, the development support system 1 judges whether to finish the registration process or not (in Step S5). To continue the registration process, the procedure returns to Step S1 to repeat the registration process. To finish the registration process, on the other hand, the procedure is finished.

The registration process shown in FIG. 6 will be specifically described on a database-by-database basis.

<Process of Registration in Request Management Database 250>

A designer principally performs the process of registering a new “request” in the request management database 250 by using the management device 2. This process, however, may be performed by using each of the programming devices 3.

At the start of the registration process, the designer selects the process of registration in the request management database 250. Next, in Step S1, the designer manipulates the input part 26 to input “Request ID,” “Request Category,” “Request Item Name,” “Request Detail” and the like as the input information. The “request ID” may be automatically given, for example, by the management device 2 when the process of registration in the request management database 250 is selected.

After the input is finished (Yes in Step S2), the registration information 240 is generated, based on the input information. As mentioned above, the database ID indicating a registration destination (that is a database in which the information is to be registered) is added to the registration information 240. In this instance, the database ID indicating the request management database 250 is added to the registration information 240.

The database management part 210 references the database ID included in the generated registration information 240 to recognize that the database serving as the registration destination of the registration information 240 is the request management database 250. Also, the database management part 210 acquires the “request ID” included in the registration information 240 to add a new record identified by the acquired “request ID” to the request management database 250. The database management part 210 stores pieces of information included in the registration information 240, as appropriate, into respective items of the added new record.

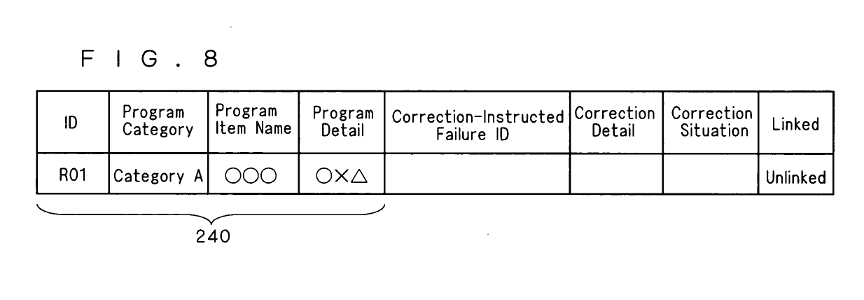

FIG. 7 illustrates a new record registered in the request management database 250. As illustrated in FIG. 7, the request management database 250 includes a plurality of items. Of these items, items corresponding to the pieces of information included in the registration information 240 and an item indicating “Linked” have information stored therein, but other items have no information stored therein when the record is registered.

The item “Linked” is an item in which information indicating whether the extent of influence of the request has already been inputted (registered) or not is stored for the corresponding “request.” At the point of registration of a new “request” in the request management database 250, the extent of influence of the request has not yet been registered in the influence extent management database 253. Thus, the database management part 210 stores information indicating “Unlinked” into the item “Linked” at the point of registration of the “request.”

In this manner, the new “request” is registered in the request management database 250. To register another “request,” the designer inputs an instruction to continue the process of registration in the request management database 250. Thus, the development support system 1 returns to Step S1 to repeat the registration process.

When all necessary “requests” are registered, the designer inputs an instruction to finish the process of registration in the request management database 250. Thus, the development support system 1 finishes the process of registration in the request management database 250.

<Process of Registration in Program Management Database 251>

A designer principally performs the process of registering a new “functional program” in the program management database 251 by using the management device 2. Instead, a programmer may perform this process by using each of the programming devices 3 because in the course of the production of the functional program there often arises a need for a new functional program.

At the start of the registration process, the designer selects the process of registration in the program management database 251. Next, in Step S1, the designer manipulates the input part 26 to input “Program ID,” “Program Category,” “Program Item Name,” “Program Detail” and the like as the input information. The “program ID” may be automatically given, for example, by the management device 2 when the process of registration in the program management database 251 is selected.

After the input is finished (Yes in Step S2), the registration information 240 is generated, based on the input information. As mentioned above, the database ID indicating the registration destination is added to the registration information 240. In this instance, the database ID indicating the program management database 251 is added to the registration information 240.

The database management part 210 references the database ID included in the generated registration information 240 to recognize that the database serving as the registration destination of the registration information 240 is the program management database 251. Also, the database management part 210 acquires the “program ID” included in the registration information 240 to add a new record identified by the acquired “program ID” to the program management database 251. The database management part 210 stores pieces of information included in the registration information 240, as appropriate, into respective items of the added new record.

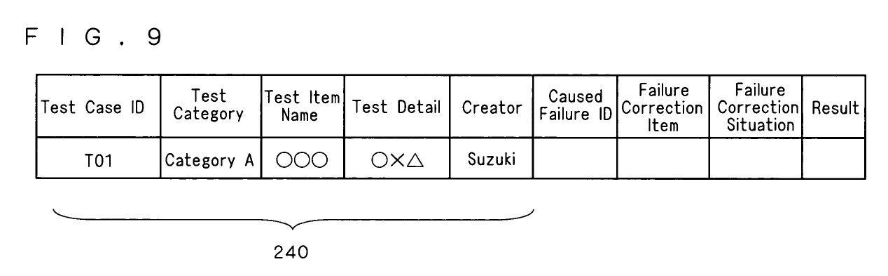

FIG. 8 illustrates a new record registered in the program management database 251. As illustrated in FIG. 8, the program management database 251 includes a plurality of items. Of these items, items corresponding to the pieces of information included in the registration information 240 and an item indicating “Linked” have information stored therein, but other items have no information stored therein when the record is registered.

The item “Linked” is an item in which information indicating whether the extent of influence of the program has already been inputted (registered) or not is stored for the corresponding “program.” At the point of registration of a new “program” in the program management database 251, the extent of influence of the program has not yet been registered in the influence extent management database 253. Thus, the database management part 210 stores information indicating “Unlinked” into the item “Linked” at the point of registration of the “program.”

In this manner, the new “program” is registered in the program management database 251. To register another “program,” the designer inputs an instruction to continue the process of registration in the program management database 251. Thus, the development support system 1 returns to Step S1 to repeat the registration process.

When all necessary “programs” are registered, the designer inputs an instruction to finish the process of registration in the program management database 251. Thus, the development support system 1 finishes the process of registration in the program management database 251.

<Process of Registration in Test Case Management Database 252>

A designer principally performs the process of registering a new “test case” in the test case management database 252 by using the management device 2. Instead, a tester may perform this process by using the evaluation device 4 because in the course of the evaluation of the product program there often arises a need for a new test case.

At the start of the registration process, the designer selects the process of registration in the test case management database 252. Next, in Step S1, the designer manipulates the input part 26 to input “Test Case ID,” “Test Category,” “Test Item Name,” “Test Detail,” “Creator” and the like as the input information. The “test case ID” may be automatically given, for example, by the management device 2 when the process of registration in the test case management database 252 is selected.

After the input is finished (Yes in Step S2), the registration information 240 is generated, based on the input information. As mentioned above, the database ID indicating the registration destination is added to the registration information 240. In this instance, the database ID indicating the test case management database 252 is added to the registration information 240.

The database management part 210 references the database ID included in the generated registration information 240 to recognize that the database serving as the registration destination of the registration information 240 is the test case management database 252. Also, the database management part 210 acquires the “test case ID” included in the registration information 240 to add a new record identified by the acquired “test case ID” to the test case management database 252. The database management part 210 stores pieces of information included in the registration information 240, as appropriate, into respective items of the added new record.

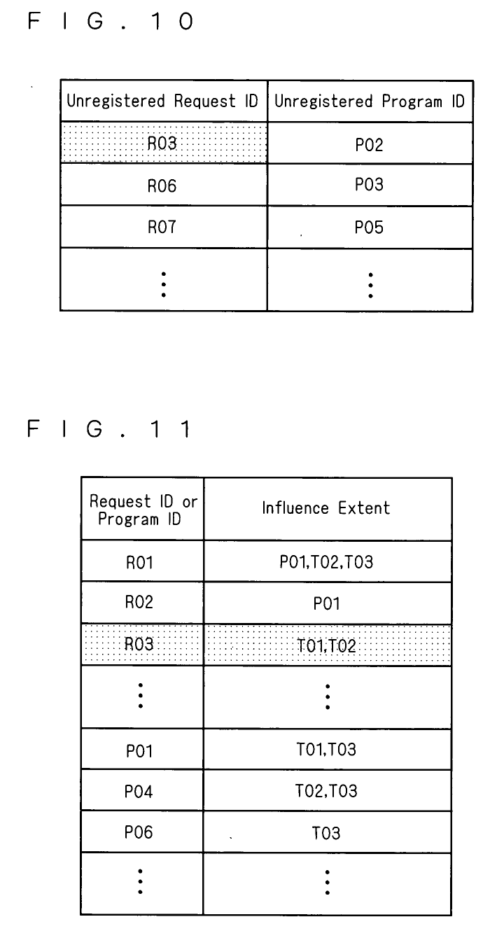

FIG. 9 illustrates a new record registered in the test case management database 252. As illustrated in FIG. 9, the test case management database 252 includes a plurality of items. Of these items, items corresponding to the pieces of information included in the registration information 240 have information stored therein, but other items have no information stored therein when the record is registered.

In this manner, the new “test case” is registered in the test case management database 252. To register another “test case,” the designer inputs an instruction to continue the process of registration in the test case management database 252. Thus, the development support system 1 returns to Step S1 to repeat the registration process.

When all necessary “test cases” are registered, the designer inputs an instruction to finish the process of registration in the test case management database 252. Thus, the development support system 1 finishes the process of registration in the test case management database 252.

<Process of Registration in Influence Extent Management Database 253>

The process of registering a new “influence extent” in the influence extent management database 253 is classified into two: the process of registering the extent of influence of a “request” and the process of registering the extent of influence of a “program.”

As the start of the registration process, a designer selects the process of registration in the influence extent management database 253. When the process of registration in the influence extent management database 253 is selected, the database management part 210 searches the request management database 250 and the program management database 251 to extract records in which the information indicating “Unlinked” is stored in the item “Linked,” thereby displaying a list of such records on the display part 27. In other words, the database management part 210 displays a list of unlinked “requests” and “programs.”

FIG. 10 shows an example of a list of “requests” and “programs” with unregistered influence extents by means of the IDs.

Next, the designer manipulates the input part 26 to select a desired “request” or “program” from the displayed list. In the example shown in FIG. 10, the request identified by the request ID “R03” is selected as the “request” the “influence extent” of which is to be registered. In this manner, the “request” or “program” the influence extent of which is to be registered is specified by the selection from the list. Alternatively, the “request” or “program” may be directly specified by inputting a desired “request ID” or “program ID.”

When the designer specifies a “request ID,” the designer additionally inputs a “request influence extent” for the request identified by the “request ID.” A “program ID” and a “test case ID” may be inputted as the “request influence extent.”

The “program ID” inputted as the “request influence extent” is a program ID indicating a program which is required to be corrected under the influence of the correction, if any, of the request. The “test case ID” inputted as the “request influence extent” is a test case ID indicating a test case (or influenceable test case) which is required to be executed again under the influence of the correction, if any, of the request.

When the designer specifies a “program ID,” the designer additionally inputs a “program influence extent” for the program identified by the “program ID.” A “test case ID” may be inputted as the “program influence extent.” The “test case ID” inputted as the “program influence extent” is a test case ID indicating a test case (or influenceable test case) which is required to be executed again under the influence of the correction, if any, of the program.

In the example shown in FIG. 10, the “request ID” is selected. Thus, the “program ID” and the “test case ID” may be inputted as the “request influence extent.” It is assumed in this example that two “test case IDs” (T01 and T02) are inputted.

After the input is finished (Yes in Step S2), the registration information 240 is generated, based on the input information. As mentioned above, the database ID indicating the registration destination is added to the registration information 240. In this instance, the database ID indicating the influence extent management database 253 is added to the registration information 240.

The database management part 210 references the database ID included in the generated registration information 240 to recognize that the database serving as the registration destination of the registration information 240 is the influence extent management database 253. Also, the database management part 210 acquires the “request ID” or “program ID” included in the registration information 240 to add a new record identified by the acquired “request ID” or “program ID” to the influence extent management database 253. The database management part 210 stores pieces of information included in the registration information 240, as appropriate, into respective items of the added new record.

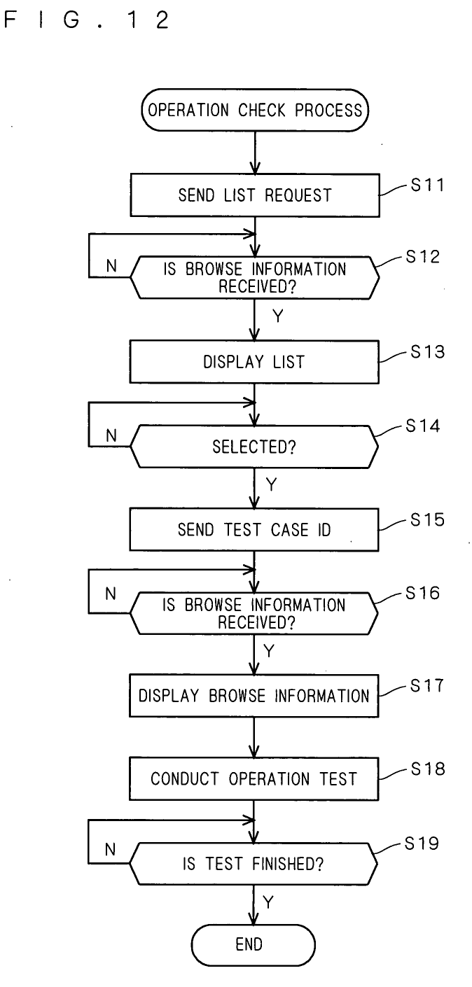

FIG. 11 illustrates the influence extent management database 253 with a new record registered therein. As illustrated in FIG. 11, the influence extent management database 253 includes an item indicating “Influence Extent” provided for each “request” or “program.” In the example shown in FIG. 11, a new record including the “request ID” indicating “R03” is registered. In the item “Influence Extent” of this record, two “test case IDs” indicating “T01, T02” are stored.

In this manner, the new “influence extent” is registered in the influence extent management database 253. When the “request influence extent” is registered, the database management part 210 searches the request management database 250 to store information indicating “Linked” in the item “Linked” for the request. When the “program influence extent” is registered, the database management part 210 searches the program management database 251 to store information indicating “Linked” in the item “Linked” for the program.

To continuously register another “influence extent” (or when another ID is displayed in the list shown in FIG. 10), the designer inputs an instruction to continue the process of registration in the influence extent management database 253.

Thus, the development support system 1 returns to Step S1 to repeat the registration process. The request identified by the request ID “R03” for which the “request influence extent” is registered is not displayed in the list of unregistered request IDs because “Linked” is stored in the item “Linked” for the request.

When all necessary “influence extents” are registered, the designer inputs an instruction to finish the process of registration in the influence extent management database 253. Thus, the development support system 1 finishes the process of registration in the influence extent management database 253.

In this manner, the “influence extents” are registered for all “requests” registered in the request management database 250 and for all “programs” registered in the program management database 251, respectively, in the development support system 1 according to the preferred embodiment.

<Process of Registration in Failure Management Database 254>

A tester principally performs the process of registering a new “failure” in the failure management database 254 by manipulating the evaluation device 4. The process of registration in the failure management database 254 is performed indirectly when the process of inputting a test result is performed, and hence will be described later.

<Operation in Conducting Test (Operation Check Process)>

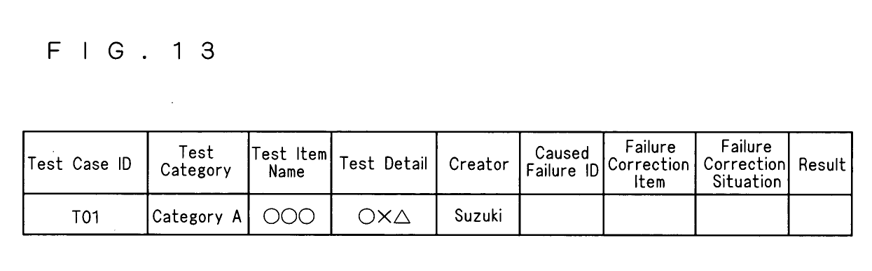

FIG. 12 is a flow diagram showing an operation check process for the product program (or functional program). In the development support system 1, a tester in the evaluation department manipulates the evaluation device 4, whereby the operation test is conducted on the product program (or functional program).

First, the tester manipulates the input part 46 of the evaluation device 4 to thereby provide an instruction to start the test (operation test). In response to this, the evaluation device 4 sends to the management device 2 a list request to transmit a list of test cases registered in the test case management database 252 (in Step S11). This operation means a browse request made from the evaluation device 4 to the management device 2.

Upon receipt of the browse request from the evaluation device 4, the management device 2 generates the browse information 242, based on the information registered in the test case management database 252, to send the browse information 242 to the evaluation device 4.

The evaluation device 4 is placed in a standby condition pending the receipt of the browse information 242 (in Step S12). Upon receipt of the browse information 242, the evaluation device 4 displays the list of test cases on the display part 47, based on the received browse information 242 (in Step S13).

This enables the tester to easily recognize which test cases are registered in the test case management database 252, that is, to easily select a test case to be executed.

The tester selects a desired test case from the list of test cases displayed on the display part 47. The evaluation device 4 is placed in a standby condition pending the selection by the tester (in Step S14). When the selection is made, the evaluation device 4 sends a browse request including the test case ID identifying the selected test case to the management device 2 (in Step S15). In the instance to be described below, “T01” is sent as the “test case ID.”

Upon receipt of the browse request sent in Step S15, the database management part 210 of the management device 2 searches the test case management database 252 to extract a record for the test case identified by the test case ID, thereby generating the browse information 242. The communication part 28 of the management device 2 sends the generated browse information 242 to the evaluation device 4.

The evaluation device 4 is placed in a standby condition pending the receipt of the browse information 242 (in Step S16). Upon receipt of the browse information 242, the evaluation device 4 displays information about the selected test case on the display part 47, based on the received browse information 242 (in Step S17).

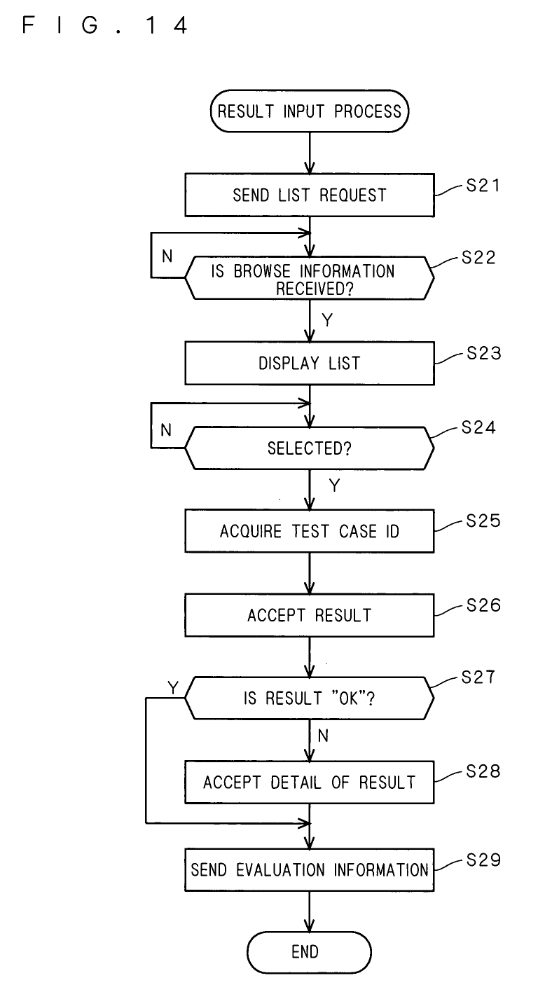

FIG. 13 shows an example of pieces of information stored in a test case. In this manner, the information about the test case to be executed (in this example, the test case ID “T01”) is displayed on the display part 47 prior to the execution of the test case in the development support system 1. This enables the tester to recognize the information about the test case (in particular, information about the item “Test Detail”) displayed on the display part 47 prior to the operation test.

In the example shown in FIG. 13, it is found that the test case has not yet been executed because no information is stored in the item “Result.” Unless a failure is caused by the execution of the test case, no information is stored in the items “Caused Failure ID,” “Failure Correction Item” and “Failure Correction Situation.” Thus, no information is stored in these items for the test case which has not yet been executed.

Next, the evaluation device 4 conducts the operation test on the product program in accordance with the manipulation of the tester (in Step S18). The evaluation device 4 judges whether the test is finished or not (in Step S19). Then, the evaluation device 4 is placed in a standby condition pending the finish of the operation test while conducting the operation test. When the test is finished (Yes in Step S19), the evaluation device 4 finishes the operation check process.

<Operation of Inputting Test Result (Result Input Process)>

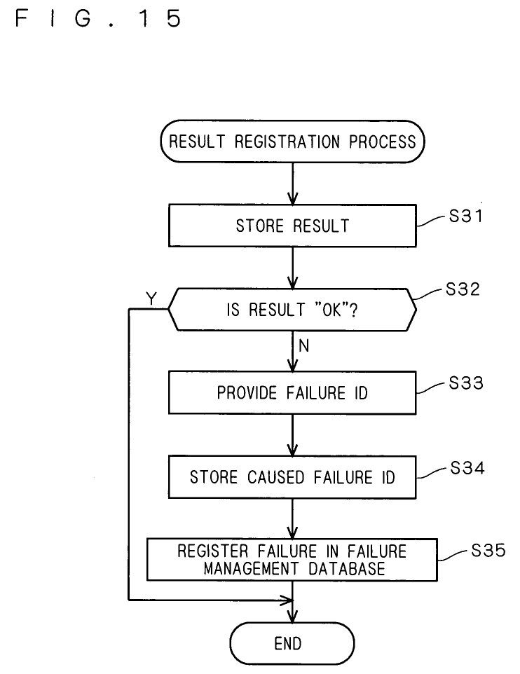

FIG. 14 is a flow diagram showing a result input process. The result input process is the process of inputting the result of the operation check process by executing the test case. In the development support system 1, a tester in the evaluation department manipulates the evaluation device 4 to perform the result input process.

First, the tester manipulates the input part 46 of the evaluation device 4 to thereby provide an instruction to start the result input process. In response to this, the evaluation device 4 sends to the management device 2 a list request to transmit a list of test cases (in Step S21) in a manner similar to Step S21.

Upon receipt of the browse request from the evaluation device 4, the management device 2 generates the browse information 242, based on the information registered in the test case management database 252, to send the browse information 242 to the evaluation device 4.

The evaluation device 4 is placed in a standby condition pending the receipt of the browse information 242 (in Step S22). Upon receipt of the browse information 242, the evaluation device 4 displays the list of test cases on the display part 47, based on the received browse information 242 (in Step S23). The list displayed in this step always shows a test case corresponding to the result to be inputted because executed test cases are inevitably registered in the test case management database 252.

This enables the tester to easily recognize which test cases are registered in the test case management database 252, that is, to easily select a test case corresponding to the result to be inputted.

The tester selects a desired test case from the list of test cases displayed on the display part 47. The evaluation device 4 is placed in a standby condition pending the selection by the tester (in Step S24). When the selection is made, the evaluation device 4 acquires the test case ID identifying the selected test case as the input information (the evaluation information 440) (in Step S25). In the instance to be described below, “T01” is selected as the “test case ID.”

Following the input of the test case ID, the tester manipulates the input part 46 to input the result of the execution of the test case identified by the inputted test case ID. Thus, the evaluation device 4 accepts the “result” of the operation test (in Step S26). In this preferred embodiment, either “OK” indicating a good result or “NG” indicating the occurrence of a failure is inputted as the “result.”

Next, the evaluation device 4 judges whether the inputted “result” is “OK” or not (in Step S27). When the inputted “result” is not “OK,” the evaluation device 4 accepts the details of the result (in Step S28). Specific examples of the details of the result are “Failure Item Name,” “Failure Detail,” “Detector,” “Significance” and the like. On the other hand, when the inputted “result” is “OK” (Yes in Step S26), Step S28 is skipped.

Next, the evaluation device 4 generates the evaluation information 440, based on the input information inputted in Steps S25, S26 and S28. The communication part 48 sends the evaluation information 440 to the management device 2 (in Step S29). Then, the result input process is finished. It should be noted that the evaluation information 440 always includes the “test case ID” corresponding to the result to be inputted, the “result” of the execution of the test case identified by the test case ID, and the like. When the “result” is “NG,” the evaluation information 440 further includes the “result detail.”

<Operation of Registering Test Result (Result Registration Process)>

FIG. 15 is a flow diagram showing a result registration process. The result registration process is the process of storing information inputted in the result input process into the test case management database 252 and the failure management database 254. In the development support system 1, the management device 2 receives the evaluation information 440 sent from the evaluation device 4 in the evaluation department to thereby perform the result registration process.

Upon receipt of the evaluation information 440, the communication part 28 generates the update information 241 from the received evaluation information 440 to transfer the update information 241 to the RAM 24. The update information 241 generated in this step includes the database ID of the test case management database 252. The update information 241 further includes the test case ID included in the evaluation information 440 and the information (“OK” or “NG”) indicating the “result.”

After the update information 241 is generated, the database management part 210 searches the test case management database 252, based on the update information 241, to store the information indicating the result of the test case in the item “Result” for the test case identified by the test case ID (in Step S31). Thus, the test case management database 252 is updated based on the update information 241 (the evaluation information 440).

Next, a judgment is made as to whether the “result” included in the update information 241 is “OK” or not (in Step S32). When the “result” is “OK,” the result registration process is finished.

When the “result” is not “OK” (No in Step S32), the management device 2 judges that a failure is caused. Then, the management device 2 automatically provides a failure ID for identifying the failure (in Step S33).

The database management part 210 stores the failure ID provided in Step S33 into the item “Caused Failure ID” for the test case identified by the test case ID included in the update information 241 (in Step S34). This also updates the test case management database 252 based on the update information 241 (the evaluation information 440).

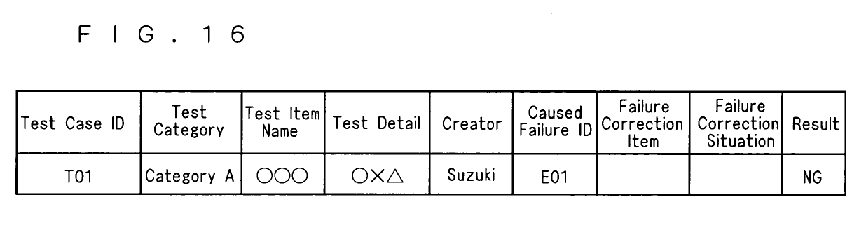

FIG. 16 illustrates the test case management database 252 about a test case in accordance with which a failure occurs in the operation test.

A comparison between FIGS. 9 and 16 shows that the record (in FIG. 9) for the test case registered in the test case registration process is updated, with information stored in the item “Caused Failure ID” and the item “Result” in the result registration process.

For a test case registered in the test case management database 252, the operation test is conducted in accordance with the test case, and the result of the operation test is inputted in the result input process and registered in the result registration process, whereby information indicating the result of the operation test is stored in the item “Result” in a manner as described above. If a failure occurs in the operation test, “NG” is stored in the item “Result,” and the failure ID indicating the failure caused by the execution of the test case is stored in the item “Caused Failure ID.”

Next, the management device 2 generates the registration information 240, based on the provided failure ID. The registration information 240 generated in this step includes the database ID of the failure management database 254, the “result detail” included in the evaluation information 440, and the provided failure ID.

After the registration information 240 is generated, the database management part 210 judges that the database to be searched is the failure management database 254, based on the database ID included in the registration information 240. Then, the database management part 210 adds a new record for the failure identified by the failure ID included in the registration information 240 to the failure management database 254, and stores the “result detail” included in the registration information 240 in the added new record. Thus, the database management part 210 registers the “failure” in the failure management database 254 (in Step S35).

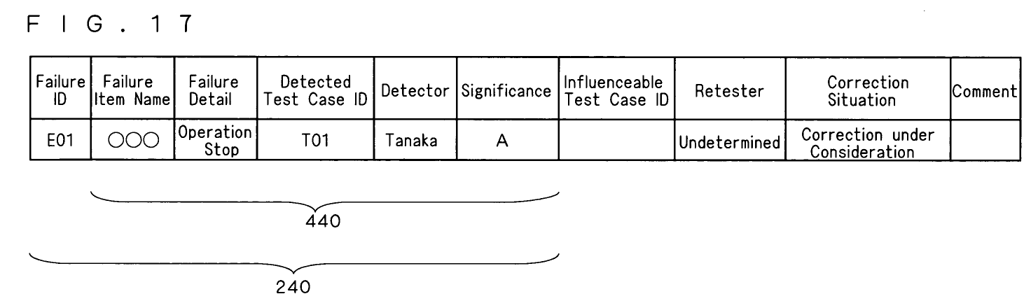

FIG. 17 illustrates a new record added to the failure management database 254. As illustrated in FIG. 17, the failure management database 254 includes a plurality of items, and pieces of information included in the registration information 240 (the evaluation information 440) are stored therein.

In this manner, the management device 2 performs the process of registration in the failure management database 254 by receiving the evaluation information 440 with the “result” indicating “NG.” When a new record (failure) is registered in the failure management database 254, information indicating “Undetermined” is automatically stored in the item “Retester” because the “Retester” is not determined. Also, information indicating “Correction under Consideration” is automatically stored in the item “Correction Situation” because a remedy against the failure is not determined.

When the process of registration in the failure management database 254 (in Step S35) is finished, the management device 2 finishes the result registration process.

<Operation of Inputting Correction Instruction (Correction Input Process)>

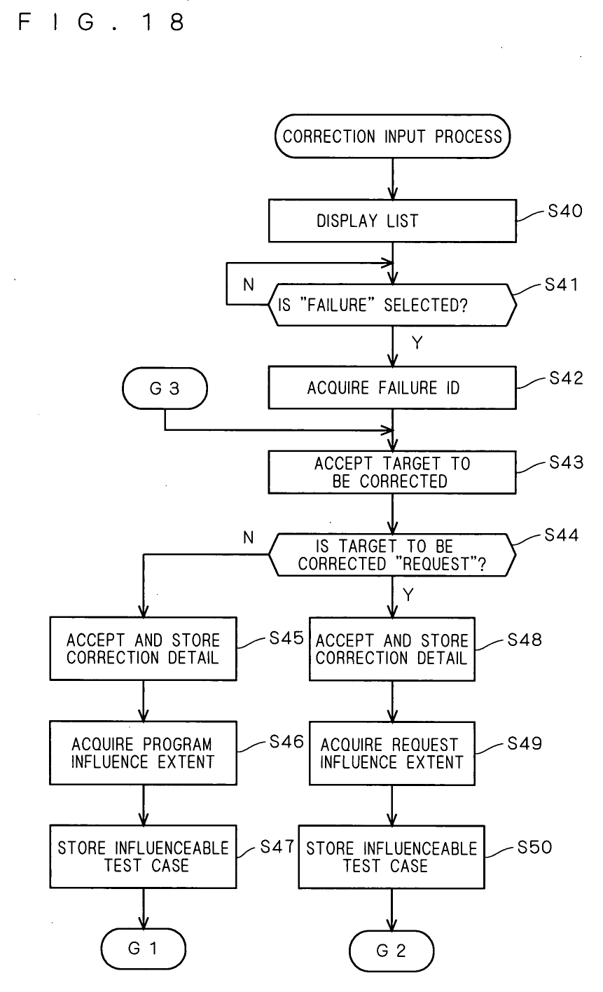

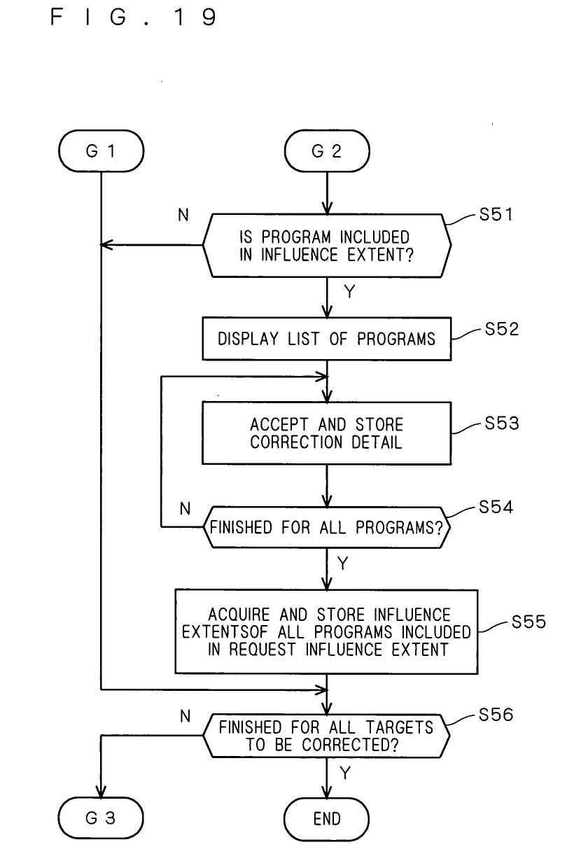

FIGS. 18 and 19 are flow diagrams showing a correction input process. The correction input process is the process of inputting an instruction to correct a failure which occurs. A designer principally uses the management device 2 to execute the correction input process.

First, the designer manipulates the input part 26 to thereby input an instruction to start the correction input process. In response to this, the input part 26 creates a browse request to request a list of failures registered in the failure management database 254, and the database management part 210 searches the failure management database 254, based on the browse request, to generate the list of failures registered in the failure management database 254 in the form of the browse information 242. The display part 27 displays the generated browse information 242 thereon (in Step S40). Thus, the instruction provided by the designer to start the correction input process causes the list of failures to appear on the display part 27 of the management device 2.

While viewing the list of failures displayed on the display part 27, the designer selects a failure corresponding to the correction instruction to be inputted from the list. When a failure is selected, the management device 2 judges that the answer to Step S41 is Yes to acquire the failure ID identifying the selected failure (in Step S42).

Next, a remedy against the selected failure is determined, the designer manipulates the input part 26 to input the “request ID” or “program ID,” thereby inputting a single target to be corrected. Thus, the management device 2 accepts one of the “request” and the “program” to be corrected during the correction process (in Step S43). In this step, the single target to be corrected may be inputted by selecting the single target to be corrected from a list of “requests” and “programs” displayed on the display part 27.

After accepting the target to be corrected, the management device 2 judges whether the target to be corrected which is accepted in Step S43 is a “request” or not (in Step S44). This judgment in Step S44 is made, for example, based on the ID (request ID or program ID) inputted in Step S43.

When the target to be corrected which is accepted in Step S43 is not a “request” (but is a “program”), the management device 2 accepts the detail of correction of the program to store the accepted correction detail in the program management database 251 (in Step S45).

Specifically, the management device 2 requests the designer to input the detail of correction, and accepts information inputted in response to the request as the detail of correction of the program. Based on the program ID inputted in Step S43, the database management part 210 searches the program management database 251 to store the accepted correction detail in the item “Correction Detail” in the record identified by the program ID. Thus, the program management database 251 is updated.

FIG. 20 illustrates the program management database 251 as updated. The example of the program management database 251 of FIG. 20 is shown as updated by performing the correction input process on the record shown in FIG. 8.

The program subject to the correction instruction is the program corresponding to the program ID inputted in Step S43. In the example of FIG. 20, the instruction to correct the program identified by “P01” is provided. The correction detail accepted in Step S45 is stored in the item “Correction Detail.” Information indicating “Instructed” is automatically stored in the item “Correction Situation” because the correction detail is stored by the correction input process. The item “Correction-Instructed Failure ID” indicates a failure against which the correction instruction is provided as the remedy. The failure ID acquired in Step S42 is stored in the item “Correction-Instructed Failure ID.”

There are cases where a single program receives a plurality of correction instructions as remedies against respective failures. A row is added for “Correction-Instructed Failure ID,” “Correction Detail” and “Correction Situation” each time another correction instruction is received, as shown in FIG. 20.

Next, the extent of influence of the program subject to the correction instruction is acquired (in Step S46), and the acquired influence extent is stored as the influenceable test case (in Step S47).

Specifically, the database management part 210 searches the influence extent management database 253, based on the program ID identifying the program, to acquire information stored in the item “Influence Extent” in the record identified by the program ID. Since only the test case ID is stored as the extent of influence of the program, the test case identified by the stored test case ID is the influenceable test case.

In the example of the influence extent management database 253 shown in FIG. 11, “T01” and “T03” are stored in the item “Influence Extent” for the record (program) identified by the program ID “P01.” Thus, “T01” and “T03” are acquired as the influence extent in Step S46 and become the influenceable test cases in the example shown in FIG. 11.

Specifically, the database management part 210 searches the failure management database 254, based on the failure ID acquired in Step S42, to store the test case ID acquired as the influence extent in the item “Influenceable Test Case ID” corresponding to the failure subject to the correction instruction.

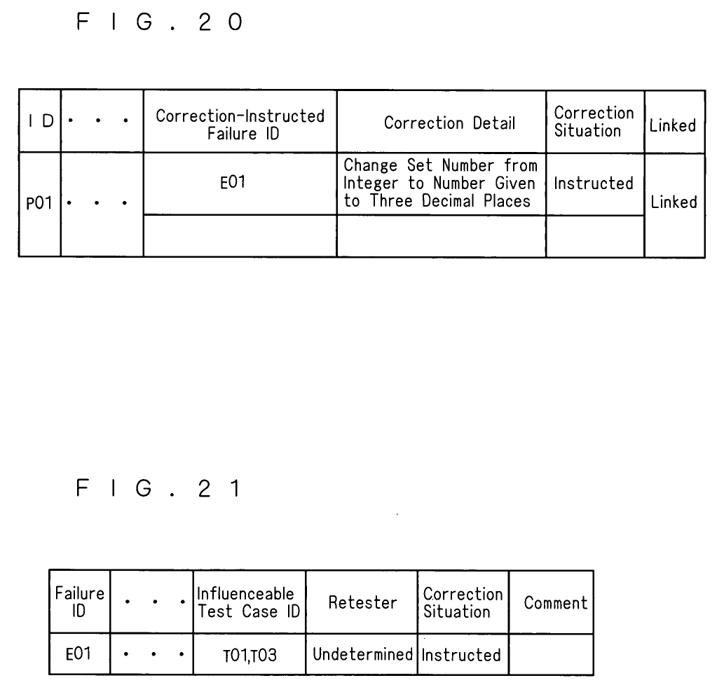

FIG. 21 illustrates the failure management database 254 as updated. The example of the failure management database 254 of FIG. 21 is shown as updated by performing the correction input process on the record shown in FIG. 17.

The failure which becomes the cause of the correction instruction is the failure corresponding to the failure ID inputted in Step S42, and the correction instruction is provided as the remedy against the failure identified by “E01” in the example shown in FIG. 21. As mentioned above, “T01” and “T03” are stored in the item “Influenceable Test Case ID.” Information indicating “Instructed” is automatically stored in the item “Correction Situation” because the correction detail is stored by the correction input process.

When the instruction to correct a program is provided in this manner, the program is corrected, whereby the influenceable test case which is required to be executed again is stored in the failure management database 254 in Step S47. This enables an operator to recognize the “influenceable test case” corresponding to the failure stored in the failure management database 254, thereby easily grasping the test case required for the failure. Therefore, the operation tests without omission are conducted after the completion of the correction of the failure. This achieves the development of a high-quality program.

Upon viewing the “correction situation” of the failure, the operator or designer can easily recognize that the instruction to correct the failure has already been provided. Thus, the operator or designer can easily select a necessary “failure” in the process of selecting the “failure” corresponding to the correction instruction to be inputted in Step S41 and the like.

After the influenceable test case is stored in the failure management database 254, the database management part 210 searches the test case management database 252, based on the test case ID indicating the influenceable test case. Then, the database management part 210 stores the failure ID acquired in Step S42 and the program ID indicating the target to be corrected which is acquired in Step S43 in association with each other in the item “Failure Correction Item” in the record identified by the test case ID. Also, the database management part 210 stores information indicating “Instructed” in the item “Failure Correction Situation” in the record in association with the “Failure Correction Item.”

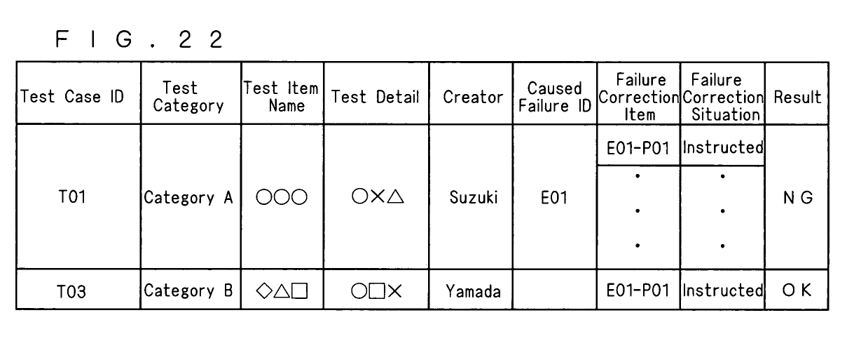

FIG. 22 illustrates records in the test case management database 252 as updated. In the example shown in FIG. 21, the test case ID indicating the influenceable test case includes “T01” and “T03.” Accordingly, the records identified by “T01” and “T03” in the test case management database 252 are updated in the example shown in FIG. 22.

As will be clear from FIG. 22, the “result” is “OK” for the test case identified by the test case ID “T03,” and it is easily found that the operation test produced a good result in accordance with the test case. In this case, no information is stored in the item “Caused Failure ID” because no “failure” occurs when the test case is executed.

In the development support system 1, however, the test case ID indicating even a test case in accordance with which a good result is obtained, such as the test case indicated by “T03,” is stored in the item “Influenceable Test Case” in the failure management database 254, based on the influence extent management database 253 as shown in FIG. 21. Thus, it will be understood that the operation test is required to be conducted in accordance with the test case indicated by “T03” again after the completion of the correction of the failure indicated by “E01.” This allows the conduct of the operation tests without omission to achieve the development of a high-quality program.

There are test cases where a plurality of correction items (correction targets) are selected for a single failure. There are also test cases where a plurality of correction items are selected for respective failures caused in accordance with another test case. Thus, each of the items “Failure Correction Item” and “Failure Correction Situation” associated with each other is capable of holding a plurality of pieces of information, as appropriate.

The management device 2 judges whether the instructions to correct all of the targets required to be corrected as a remedy against the failure are finished or not (in Step S56). If there remains any target to be corrected for which the correction instruction is not inputted, the processing in Step S43 and its subsequent steps is repeated. If all of the targets to be corrected are processed, the correction input process is finished.

On the other hand, when the target to be corrected which is accepted in Step S43 is a “request,” the management device 2 accepts the detail of correction of the request to store the accepted correction detail in the request management database 250 (in Step S48).

Specifically, the management device 2 displays a message and the like on the display part 27 to request the designer to input the detail of correction, and accepts information inputted in response to the request as the detail of correction of the request. Based on the request ID inputted in Step S43, the database management part 210 searches the request management database 250 to store the accepted correction detail in the item “Correction Detail” in the record identified by the request ID. Thus, the request management database 250 is updated.

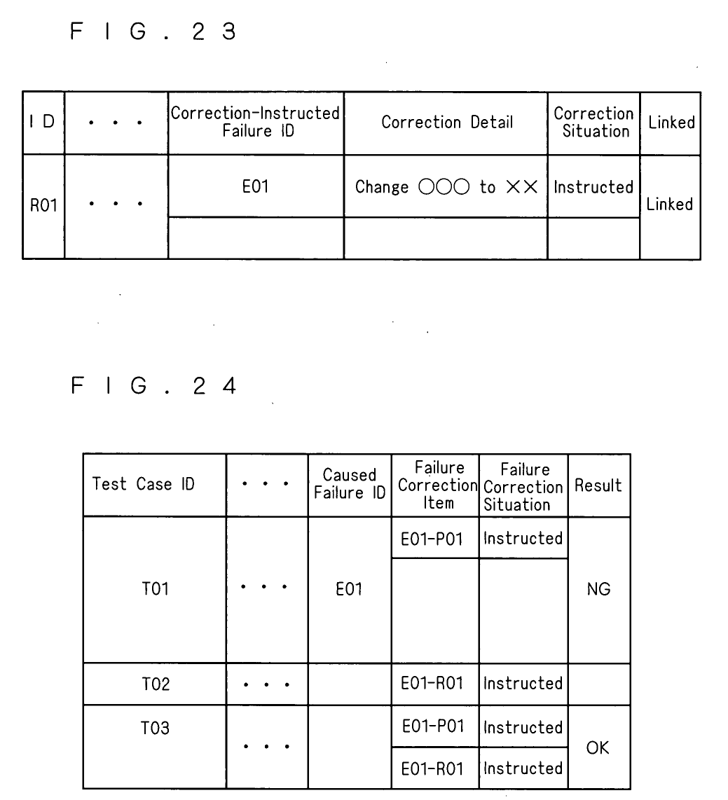

FIG. 23 illustrates the request management database 250 as updated. The example of the request management database 250 of FIG. 23 is shown as updated by performing the correction input process on the record shown in FIG. 7.

The request subject to the correction instruction is the request corresponding to the request ID inputted in Step S43. In the example of FIG. 23, the instruction to correct the request identified by “R01” is provided. The correction detail accepted in Step S48 is stored in the item “Correction Detail.” Information indicating “Instructed” is automatically stored in the item “Correction Situation” because the correction detail is stored by the correction input process. The item “Correction-Instructed Failure ID” indicates a failure against which the correction instruction is provided as the remedy. The failure ID acquired in Step S42 is stored in the item “Correction-Instructed Failure ID.”

There are cases where, like a program, a request receives a plurality of correction instructions as remedies against respective failures. A row is added for “Correction-Instructed Failure ID,” “Correction Detail” and “Correction Situation” each time another correction instruction is received.

Next, the extent of influence of the request subject to the correction instruction is acquired (in Step S49), and the acquired influence extent is stored as the influenceable test case (in Step S50).

Specifically, the database management part 210 searches the influence extent management database 253, based on the request ID identifying the request, to acquire information stored in the item “Influence Extent” in the record identified by the request ID. Not only a test case ID but also a program ID is stored as the extent of influence of the request in some cases. In this instance, it is assumed that only the test case identified by the test case ID stored as the “influence extent” of the request is the influenceable test case.

In the example of the influence extent management database 253 shown in FIG. 11, “P01,” “T02” and “T03” are stored in the item “Influence Extent” for the record (request) identified by the request ID “R01.” Thus, “P01,” “T02” and “T03” are acquired as the influence extent in Step S46, and “T02” and “T03,” of the three, become the influenceable test cases in the example shown in FIG. 11. In other words, the influence extent of the program indicated by the program ID “P01” is not treated as the influenceable test case in Step S50.

Specifically, the database management part 210 searches the failure management database 254, based on the failure ID acquired in Step S42, to store the test case ID acquired as the request influence extent in the item “Influenceable Test Case ID” corresponding to the failure subject to the correction instruction.

Additionally, the database management part 210 searches the test case management database 252, based on the test case ID indicating the influenceable test case, to update the “Failure Correction Item” and “Failure Correction Situation” in the record identified by the test case ID.

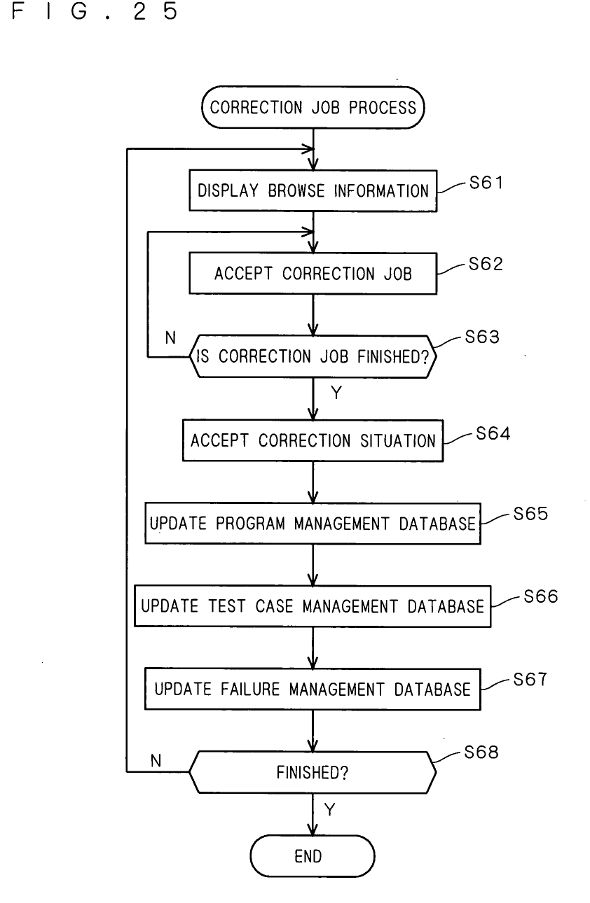

FIG. 24 illustrates records in the test case management database 252 as updated. As illustrated in FIG. 24, the items “Failure Correction Item” and “Failure Correction Situation” hold pieces of information and are updated for the test cases indicated by “T02” and “T03.”

Next, a judgment is made as to whether a program is included in the “request influence extent” acquired in Step S49 or not (in Step S51). If no program is included in the “request influence extent,” the processing in Step S56 and its subsequent steps is executed.

If programs are included in the “request influence extent” (Yes in Step S51), the programs are displayed in list form on the display part 27 (in Step S52). Specifically, a list of program IDs acquired as the “request influence extent” is displayed on the display part 27.

This enables the designer to easily recognize the program which is influenced by the correction of the request. Such a program can be said to have a relatively high probability that the remedy against the failure needs a correction instruction. In the development support system 1, an operator is required to judge and determine the “program” and “request” which need the correction instruction. The development support system 1 is configured to display a list of programs which have a substantial need for the correction instruction. This enables the operator to provide instructions to correct the programs which need the correction instruction with reliability without omission.

Then, the management device 2 accepts the detail of correction of a program selected from the displayed list, and stores the accepted correction detail in the program management database 251 (in Step S53).

Specifically, the management device 2 displays a message and the like on the display part 27 to request the designer to input the detail of correction, and accepts information inputted in response to the request as the detail of correction of the program. Based on the program ID acquired as the “request influence extent” in Step S49, the database management part 210 searches the program management database 251 to store the accepted correction detail in the item “Correction Detail” in the record identified by the program ID. Thus, the program management database 251 is updated for the program acquired as the “request influence extent,” if required (if selected), and the detail of correction thereof is stored in the program management database 251.

When the process in Step S53 is completed for all of the programs which need the correction instruction among the programs displayed in list form in Step S52 (the programs acquired as the “request influence extent”), the management device 2 judges that the answer to Step S54 is Yes. The judgment in Step S54 is made, based on information inputted by the designer who manipulates the input part 26.

Next, the management device 2 acquires the “influence extents” of all of the programs included in the request influence extent from the influence extent management database 253, and stores the acquired influence extents as the influenceable test cases in the failure management database 254 (in Step S55). In other words, the influenceable test cases stored in this step are those which are required to be executed again because of the correction of a request in Steps S50 and S55 even when the instruction to correct the request is provided.

This enables the operator to recognize the “influenceable test cases” corresponding to the failure, thereby easily grasp the required test cases. Therefore, the operation tests without omission are conducted after the completion of the correction of the failure. This achieves the development of a high-quality program.

After the influenceable test cases are stored in Step S55, the test case management database 252 is updated, based on the test case IDs indicating the influenceable test cases in a manner similar to Steps S47 and S50.

Then, the management device 2 judges whether the instructions to correct all of the targets required to be corrected as a remedy against the failure are finished or not (in Step S56). If there remains any target to be corrected for which the correction instruction is not inputted, the processing in Step S43 and its subsequent steps is repeated. If all of the targets to be corrected are processed, the correction input process is finished.

Although not discussed in detail, when there is a need to add a new “request” or “program” as the remedy against the failure or when the extent of influence of a request (or program) varies, the process of registration in the request management database 250, the program management database 251 or the influence extent management database 253 may be executed as required prior to the execution of the correction input process of Step S43.

<Operation in Correction Job>

In the development support system 1, the job of correcting a “request” and the job of correcting a “program” are performed in a substantially similar manner. The correction job in the development support system 1 will be described by taking the job of correcting the program as an example.

FIG. 25 is a flow diagram showing the operation in a correction job process. A programmer in the programming department manipulates the input part 36 of the programming device 3 to input an instruction to start the correction job process, whereby the correction job process is started.

Upon start of the correction job process, the programming device 3 makes a browse request for a list of programs to the management device 2. In response to the browse request, the management device 2 sends the browse information 242 including a list of programs registered in the program management database 251 to the programming device 3. Upon receipt of the browse information 242 including the list of programs, the programming device 3 displays the list of programs on the display part 37, based on the browse information 242.

Next, the programmer manipulates the input part 36 to select a desired program from the displayed list. In response to this manipulation, the programming device 3 sends a browse request for the selected program with the program ID corresponding to the selected program to the management device 2.

In response to this browse request, the management device 2 sends the browse information 242 including information stored in the record of the selected program to the programming device 3. Upon receipt of the browse information 242, the programming device 3 displays the browse information 242 on the display part 37 (in Step S61). This enables the programmer to browse the information stored in the program management database 251 about the desired program.

When the instruction to correct the program is provided as in the example shown in FIG. 20, the detail of the correction instruction is displayed in the item “Correction Detail.” This enables the programmer to recognize that the instruction to correct the program is provided, and also to recognize the detail thereof.

Next, the programmer performs the job of correcting the program in accordance with the information displayed as the “Correction Detail.”

While accepting the correction job (in Step S62), the programming device 3 judges whether the correction job is finished or not (in Step S63). The programming device 3 continues the processing in Step S62 until the correction job is finished.

After the programmer finishes the job of correcting the program, the programming device 3 judges that the answer to Step S63 is Yes, and accepts the correction situation (in Step S64). Specifically, the programming device 3 displays a message prompting for the input of information indicating the correction situation on the display part 37, and accepts the information inputted in response to the message as the information indicating the correction situation.

The programming device 3 generates the program information 340, based on the program ID corresponding to the program selected by the programmer (or the program subjected to the correction job), the failure ID (correction-instructed failure ID) which becomes the cause of the correction instruction, and the accepted information.

In Step S64, information indicating, for example, “Correcting,” “Corrected” and the like is included in the program information 340. When a plurality of correction instructions are displayed for a single program, the program information 340 is generated for each of the correction instructions.

After the program information 340 is generated, the programming device 3 sends the generated program information 340 to the management device 2. When the communication part 28 of the management device 2 receives the program information 340, the communication part 28 generates the update information 241 based on the program information 340. Then, the database management part 210 searches the program management database 251, based on the program ID included in the update information 241. The database management part 210 stores the information indicating the correction situation included in the update information 241 in the item “Correction Situation” in the record identified by the program ID.

In this manner, the database management part 210 updates the program management database 251, based on the update information 241 (in Step S65). In other words, the information indicating the inputted correction situation is stored in the item “Correction Situation” of the program in accordance with the progress of the correction job of the programmer.

Next, the database management part 210 updates the test case management database 252 (in Step S66). Specifically, the database management part 210 searches the test case management database 252 for the “failure correction item,” based on the correction-instructed failure ID and the program ID included in the update information 241 to extract the failure correction item corresponding to the failure ID and the program ID stored in association with each other in the item “Failure Correction Item.” The database management part 210 stores the information indicating the correction situation included in the update information 241 in the item “Correction Situation” associated with the extracted failure correction item. Thus, the “failure correction situation” stored in the test case management database 252 is updated by the database management part 210 based on the update information 241 (the program information 340).

The database management part 210 also updates the failure management database 254 (in step S67). Specifically, the database management part 210 acquires all of the test case IDs indicated in the item “Influenceable Test Case ID” for each failure registered in the failure management database 254. Next, the database management part 210 searches the test case management database 252, based on the acquired test case IDs acquired for each failure, and updates the “correction situation” of the failure so as to indicate “Corrected” only when all of the pieces of information stored in the item “Failure Correction Situation” in the records indicated by the test case IDs indicate “Corrected.”

When all of the pieces of information stored in the item “Failure Correction Situation” indicate “Corrected” in the record for a test case, the operation check is executable in accordance with the test case. The test case under such conditions is referred to as an “executable test case.”

To allow the operation check process (to be described later) to be executed on a given failure, it is necessary that all of the test cases indicated in the item “Influenceable Test Case ID” are “executable test cases.” Thus, the database management part 210 performs the above-mentioned process to detect whether all of the influenceable test cases are “executable test cases” or not for each failure. Only when all of the influenceable test cases are “executable test cases” for a failure, the database management part 210 updates the “correction situation” of the failure so as to indicate “Corrected.”

In this manner, the progress of the correction job by the programmer is stored in each of the databases (the program management database 251, the test case management database 252 and the failure management database 254) in the development support system 1. This facilitates the recognition of the correction situation, as required.

After the update of the failure management database 254 is finished, a judgment is made as to whether to finish the correction job process or not (in Step S68). To further continue the correction job process, the procedure returns to Step S61 to repeat the processing. To finish the correction job process, the procedure is finished.

<Operation Recheck Process>

In the course of the development of a program, it is necessary to make an operation check in accordance with a test case and, if a failure is caused thereby, to make the operation check again upon completion of the remedy (correction job) against the failure.

The tester manipulates the input part 46 of the evaluation device 4 to input an instruction to start the operation recheck process, thereby starting the operation recheck process. In response to the instruction, the evaluation device 4 sends a browse request for browsing a list of previously caused failures to the management device 2.

In response to the browse request, the database management part 210 of the management device 2 generates the browse information 242 including a list of failures registered in the failure management database 254 to send the browse information 242 to the evaluation device 4.

Upon receipt of the browse information 242, the evaluation device 4 displays the received browse information 242 on the display part 47. This enables the tester to easily grasp the failures registered in the failure management database 254.

Next, the tester manipulates the input part 46 to select a desired failure (to be subjected to the operation recheck) from the list of failures. Thus, the evaluation device 4 acquires the failure ID identifying the selected failure to send the browse request for browsing the failure together with the acquired failure ID to the management device 2.

In response to the browse request, the database management part 210 of the management device 2 searches the failure management database 254 to extract a record identified by the failure ID. Then, the database management part 210 generates the browse information 242, based on the extracted record, and sends the browse information 242 to the evaluation device 4.

Upon receipt of the browse information 242, the evaluation device 4 displays the received browse information 242 on the display part 47. This enables the tester to browse the information about the desired failure.

Next, the evaluation device 4 judges whether the information stored in the item “Correction Situation” in the browse information 242 indicates “Corrected” or not. When the information does not indicate “Corrected,” the evaluation device 4 displays on the display part 47 a message indicating that the operation recheck process cannot be executed on the failure, and completes the processing.

When the information indicates “Corrected,” on the other hand, the evaluation device 4 sends a browse request to the management device 2, based on all of the test case IDs stored in the “Influenceable Test Case ID” for the failure, and displays the browse information 242 received in response to the browse request on the display part 47. Thus, the pieces of information stored in the records corresponding to all of the influenceable test cases are displayed on the display part 47. This enables the tester to easily grasp the test detail for the operation recheck regarding the failure. This allows the conduct of the operation tests without omission to achieve the development of a high-quality program.

In the description of the above-mentioned preferred embodiment, both the input of the information about a program to be produced and the production of the program are carried out in the programming devices 3. However, the production of the program may be carried out in another external device because it is sufficient for the development support system 1 only to be able to acquire the information about the program to be produced.

Likewise, both the input of the information about the result of a test case and the execution of the test case are carried out in the evaluation device 4 in the above-mentioned preferred embodiment. However, the execution of the test case may be carried out in another external device because it is sufficient for the development support system 1 only to be able to acquire the information about the result of the test case.

It is possible to perform the data communication between the programming devices 3 and the evaluation device 4 in the description of the above-mentioned preferred embodiment. When the databases are stored in the management device 2, it is sufficient for the programming devices 3 and evaluation device 4 only to be able to perform the data communication with the management device 2. In other words, the data communication between the programming devices 3 and the evaluation device 4 may be impossible.

The five databases are constructed in the description of the above-mentioned preferred embodiment. The structure of the databases is not limited to that described above if it is possible to easily manage necessary information. As an example, the item “Influence Extent” may be provided in each record of the request management database 250 and the program management database 251 so that the information stored in the influence extent management database 253 is stored in this item. Such a configuration eliminates the need to provide the influence extent management database 253 independently of the other databases.

While the invention has been described in detail, the foregoing description is in all aspects illustrative and not restrictive. It is understood that numerous other modifications and variations can be devised without departing from the scope of the invention.

What is claimed is:

1. A development support system for supporting development of a program, comprising:
an input part for accepting an instruction input from an operator;
an influence extent management part for previously holding the extent of influence of each program, based on the instruction input accepted by said input part;
an acquisition part, based on an instruction input accepted by said input part and indicating program correction, for specifying a to-be-corrected program from the instruction input indicating said program correction to acquire the extent of influence of said to-be-corrected program from the extent of influence of each program held in said influence extent management part; and
a specification part for specifying an influenceable test case, based on the extent of influence of said to-be-corrected program acquired by said acquisition part, said influenceable test case being a test case to be executed after correction of said to-be-corrected program based on the instruction input indicating said program correction is completed.

2. The development support system according to claim 1, wherein:
said influence extent management part previously holds the extent of influence of each request corresponding to a program, based on the instruction input accepted by said input part;
based on an instruction input accepted by said input part and indicating request correction, said acquisition part specifies a to-be-corrected request from the instruction input indicating said request correction to acquire the extent of influence of said to-be-corrected request from the extent of influence of each request held in said influence extent management part; and
said specification part specifies the influenceable test case, based on the extent of influence of said to-be-corrected request acquired by said acquisition part, said influenceable test case being a test case to be executed after correction of said to-be-corrected request based on the instruction input indicating said request correction is completed.

3. The development support system according to claim 2, wherein
the extent of influence of a request indicates a program required to be corrected because of the correction of said request.

4. The development support system according to claim 1, wherein:
said input part accepts corrected information indicating that correction of said to-be-corrected program is completed; and
a judgment as to whether said influenceable test case is executable or not is made, based on said corrected information.

5. A development support system for supporting development of a program, comprising:
an input part for accepting an instruction input from an operator;
an influence extent management part for previously holding the extent of influence of each request corresponding to a program, based on the instruction input accepted by said input part;
an acquisition part, based on an instruction input accepted by said input part and indicating request correction, for specifying a to-be-corrected request from the instruction input indicating said request correction to acquire the extent of influence of said to-be-corrected request from the extent of influence of each request held in said influence extent management part; and
a specification part for specifying an influenceable test case, based on the extent of influence of said to-be-corrected request acquired by said acquisition part, said influenceable test case being a test case to be executed after correction of said to-be-corrected request based on the instruction input indicating said request correction is completed.

6. The development support system according to claim 5, wherein
the extent of influence of a request indicates a program required to be corrected because of the correction of said request.

7. The development support system according to claim 5, wherein:
said input part accepts corrected information indicating that correction of a to-be-corrected program is completed; and
a judgment as to whether said influenceable test case is executable or not is made, based on said corrected information.

8. A method of supporting development of a program, comprising the steps of:
(a) accepting an instruction input from an operator;
(b) previously holding the extent of influence of each program, based on the accepted instruction input;
(c) based on an accepted instruction input indicating program correction, specifying a to-be-corrected program from the instruction input indicating said program correction to acquire the extent of influence of said to-be-corrected program from the extent of influence of each program held in said step (b); and
(d) specifying an influenceable test case, based on the extent of influence of said to-be-corrected program, said influenceable test case being a test case to be executed after correction of said to-be-corrected program based on the instruction input indicating said program correction is completed.

9. A recording medium with a development support program recorded thereon, said development support program being executed by a computer to cause said computer to perform the steps of:
(a) accepting an instruction input from an operator;
(b) previously holding the extent of influence of each program, based on the accepted instruction input;
(c) based on an accepted instruction input indicating program correction, specifying a to-be-corrected program from the instruction input indicating said program correction to acquire the extent of influence of said to-be-corrected program from the extent of influence of each program held in said step (b); and
(d) specifying an influenceable test case, based on the extent of influence of said to-be-corrected program, said influenceable test case being a test case to be executed after correction of said to-be-corrected program based on the instruction input indicating said program correction is completed.
